(19) United States
(12) Patent Application Publication
(10) Pub. No.: US 2025/0129780 A1
(43) Pub. Date: Apr. 24, 2025

(54) ELECTRIC COMPRESSOR

(71) Applicant: Hanon Systems, Daejeon (KR)

(72) Inventors: Hyun Woo Lee, Daejeon (KR); Min Gyu Kim, Daejeon (KR); Sang Woo Bae, Daejeon (KR); Jong Myung Seok, Daejeon (KR); Hye Rim An, Daejeon (KR); Hew Nam Ahn, Daejeon (KR); Sung Taeg Oh, Daejeon (KR); Je Su Yun, Daejeon (KR)

(21) Appl. No.: 18/580,423

(22) PCT Filed: Feb. 28, 2023
(86) PCT No.: PCT/KR2023/002829

§ 371 Date: Jan. 18, 2024

(30) Foreign Application Priority Data
Mar. 21, 2022 (KR) 10-2022-0034947

(51) Int. Cl. F04C 23/02; F04C 18/02

(52) U.S. Cl. CPC F04C 23/02; F04C 18/0215

(57) ABSTRACT

An electric compressor including: a motor unit configured to generate power; a compression unit configured to receive the power from the motor unit and to compress a refrigerant; an inverter configured to control the motor unit; and a cover configured to be coupled to one side of the inverter. The cover includes: a metal plate formed in a shape corresponding to the inverter; a first resin portion configured to be disposed on an inside of the metal plate; and a second resin portion configured to be disposed on an outside of the metal plate in such a way as to correspond to some areas of the first resin portion.

### CROSS REFERENCE TO RELATED PATENT APPLICATIONS

This is a U.S. national phase patent application of PCT/KR2023/002829 filed Feb. 28, 2023 which claims the benefit of and priority to Korean Patent Application No. 10-2022-0034947, filed on Mar. 21, 2022, the entire contents of each of which are incorporated herein by reference.

### TECHNICAL FIELD

The present disclosure relates to an electric compressor and more particularly to an electric compressor that is driven by a motor.

### BACKGROUND ART

Generally, an air conditioning (A/C) system for heating and cooling the interior of a vehicle is installed in the vehicle. This air conditioning system includes a compressor as a component of a cooling system. The compressor compresses a low-temperature and low-pressure gaseous refrigerant drawn from an evaporator into a high-temperature and high-pressure gaseous refrigerant and transmits it to a condenser.

A compressor applied to the air conditioning system for a vehicle includes a swash plate compressor that uses the power of an engine and an electric compressor that drives a compression mechanism by a motor.

Among these compressors, the electric compressor compresses the refrigerant by driving the compression mechanism such as a scroll by a motor. An inverter that controls the motor is provided on one side of the motor.

The inverter includes a circuit board on which various elements are mounted. Also, a cover for protecting the inverter is installed on one side of the inverter. Here, the cover not only protects the inverter, but also shields electromagnetic waves.

However, it is required for the cover to have a size enough to cover the entire inverter in accordance with the purpose of protecting the inverter and to be made of a metallic material in order to shield electromagnetic waves.

The cover of the conventional electric compressor which is for satisfying these conditions is heavy and is manufactured to be seamless in order to prevent foreign substances from flowing into the inverter by using a diecasting method, which requires a high processing cost.

### SUMMARY

The purpose of the present disclosure is to solve the above-mentioned problems of the conventional electric compressor and to provide an electric compressor having a cover that not only is capable of protecting an inverter and of shielding electromagnetic waves but also has its reduced weight.

One embodiment is an electric compressor including: a motor unit configured to generate power; a compression unit configured to receive the power from the motor unit and to compress a refrigerant; an inverter configured to control the motor unit; and a cover configured to be coupled to one side of the inverter. The cover includes: a metal plate; a first resin portion configured to be disposed on an inside of the metal plate; and a second resin portion configured to be disposed on an outside of the metal plate in such a way as to correspond to some areas of the first resin portion.

The inverter may include a housing that forms an exterior thereof, and a circuit board which is received in the housing and on which a plurality of elements is mounted. At least a portion of the first resin portion may be formed to face the circuit board.

The second resin portion may correspond to a peripheral shape of the first resin portion and may be formed to have a predetermined area.

The first resin portion and the second resin portion may be integrally injection-molded.

A plurality of through holes may be formed in the metal plate, and the first resin portion and the second resin portion may be integrally connected through the through hole.

The plurality of through holes may be disposed along an outer perimeter of the first resin portion and the second resin portion.

The first resin portion may include an inner surface that is formed to have a shape corresponding to the circuit board, and a side wall that protrudes toward the circuit board along a perimeter of the inner surface.

A sealing member seating portion may be integrally formed on an outer peripheral surface of the side wall, and a sealing member may be mounted on the sealing member seating portion.

The second resin portion may be formed in on opposite sides of the sealing member seating portion and the sealing member with the metal plate placed therebetween and may cover the through hole.

A rib protruding toward the circuit board may be formed on the first resin portion.

The rib may protrude to a height less than the side wall.

The electric compressor may include an area where the ribs are formed to protrude at different heights such that the ribs avoid interference with the element.

The rib may further include a middle rib that has a relatively lower protrusion height than other ribs.

The middle rib may be formed to have a greater spaced distance from the element than those of other ribs.

A central plate portion may be formed in a center of the metal plate, and the central plate portion may be formed relatively thicker than other portions of the metal plate.

The metal plate may include a plurality of flanges that protrudes further outward than the first and second resin portions in a radial direction of the metal plate. A fastening hole may be formed to pass through the flange.

According to the embodiment, it is possible to make the electric compressor lighter by reducing the weight of the cover.

Also, since the metal plate has a simple shape, lower processing cost is required, resulting in the reduction of the cost of the electric compressor.

### DESCRIPTION OF DRAWINGS

FIG. 1 is a front view of an electric compressor according to an embodiment of the present disclosure;

FIG. 2 is an exploded perspective view showing an inverter and a cover of the electric compressor according to the embodiment of the present disclosure;

FIG. 3 is a perspective view showing the cover of FIG. 2;

FIG. 4 is a view showing a metal plate of the cover of FIG. 2; and

FIG. 5 is a perspective view showing a cover of an electric compressor according to another embodiment of the present disclosure.

### DESCRIPTION OF AN EMBODIMENT

Hereinafter, an electric compressor according to an embodiment of the present disclosure will be described with reference to the accompanying drawings.

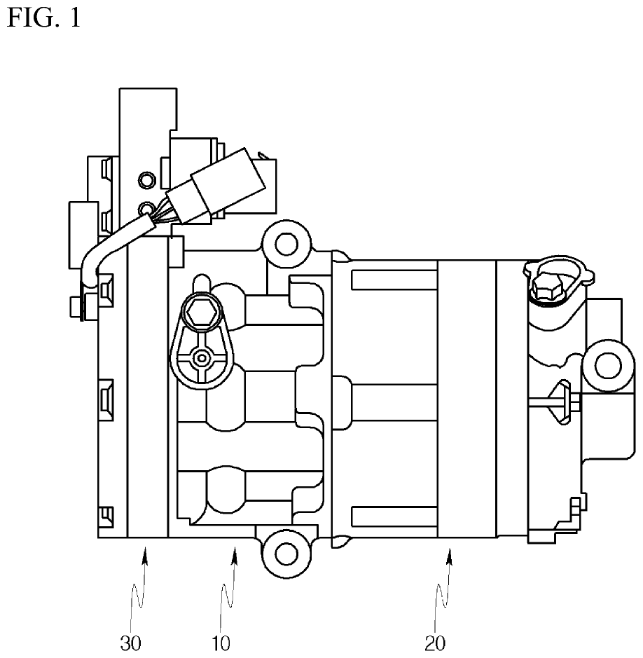

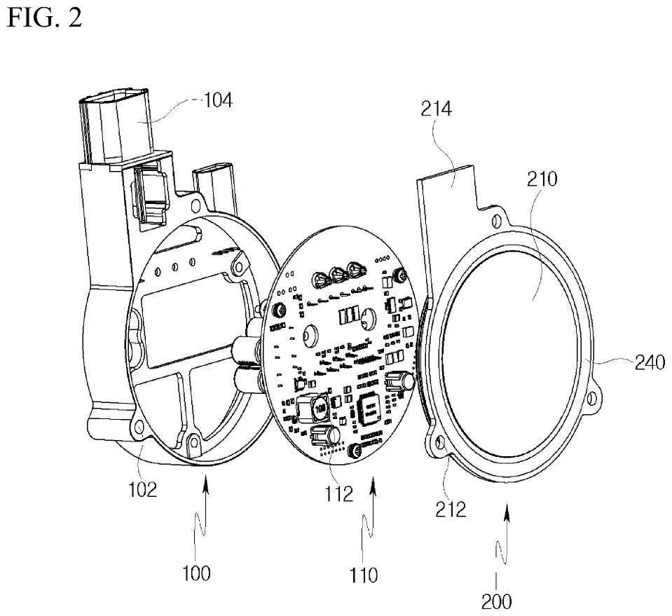

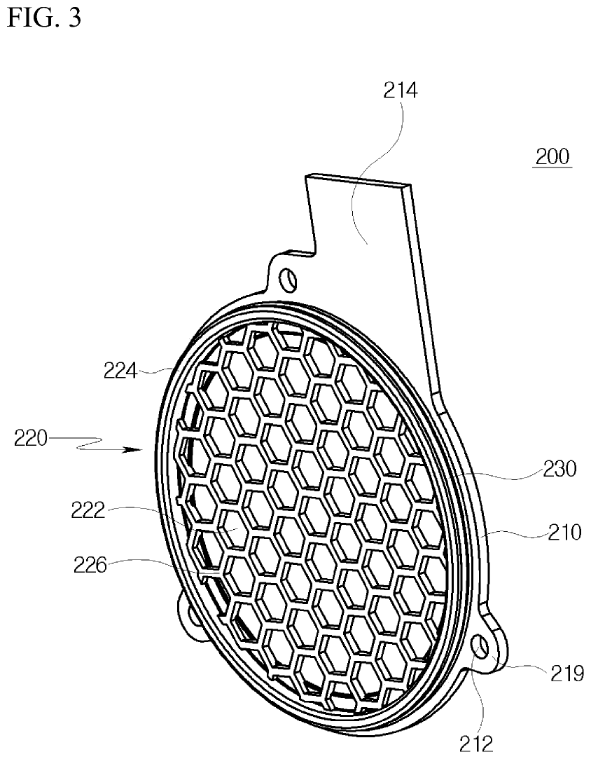

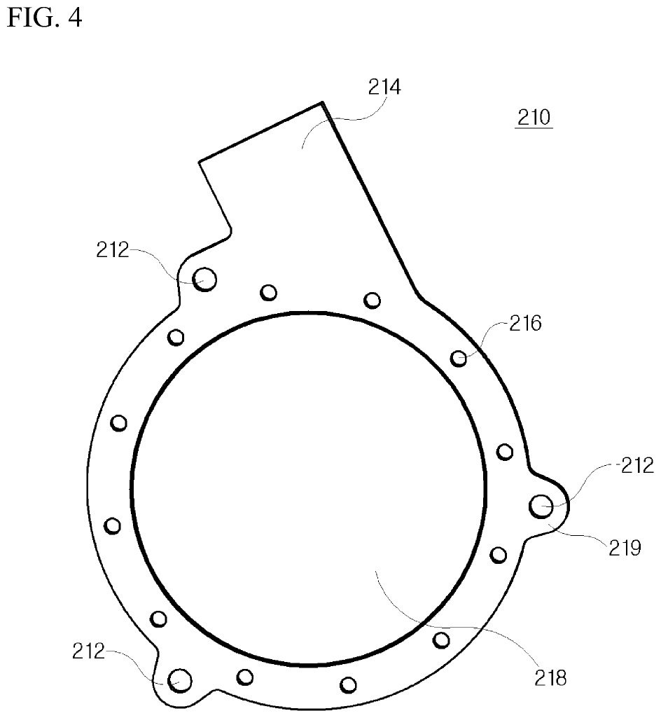

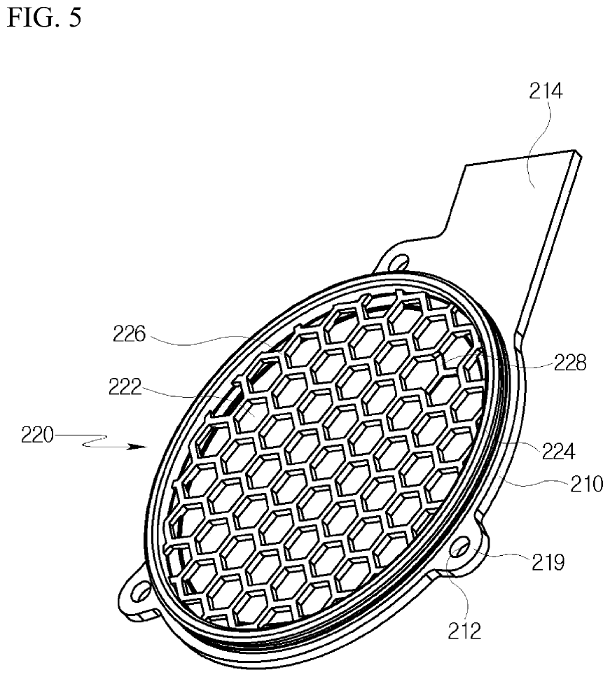

FIG. 1 is a front view of an electric compressor according to the embodiment of the present disclosure. FIG. 2 is an exploded perspective view showing an inverter and a cover of the electric compressor according to the embodiment of the present disclosure. FIG. 3 is a perspective view showing the cover of FIG. 2. FIG. 4 is a view showing a metal plate of the cover of FIG. 2. FIG. 5 is a perspective view showing a cover of an electric compressor according to another embodiment of the present disclosure.

Also, the below-mentioned terms are defined in consideration of the functions in the present disclosure and may be changed according to the intention of users or operators or custom. The following embodiments do not limit the scope of the present disclosure and are merely exemplary of the components presented in the claims of the present disclosure.

Parts irrelevant to the description will be omitted for a clear description of the present disclosure. The same or similar reference numerals will be assigned to the same or similar components throughout this specification. Throughout this specification, when it is mentioned that a portion “includes” an element, it means that the portion does not exclude but further includes other elements unless there is a special opposite mention.

The electric compressor according to an embodiment of the present disclosure includes a motor unit 10 that generates power, a compression unit 20 that receives the power from the motor unit 10 and compresses a refrigerant, an inverter 30 that controls the motor unit 10, and a cover 200 that protects the inverter 30.

The motor unit 10 generates a rotational force and includes a stator and a rotor. A rotary shaft is coupled to the rotor. The stator is a type of electromagnet and is fixedly installed, and the rotor is installed inside the stator coaxially with the stator. The rotary shaft is installed in such a way as to rotate together with the rotor.

The compression unit 20 receives the power from the motor unit 10 and compresses the refrigerant. The compression unit 20 includes, for example, a fixed scroll and an orbiting scroll. The fixed scroll is fixedly installed, and the orbiting scroll rotates together with the rotor in a state of being coupled to the rotary shaft and gradually reduces a refrigerant compression space formed between the fixed scroll and the orbiting scroll. In other words, the refrigerant introduced into the compression space is compressed by the relative rotation of the fixed scroll and the orbiting scroll.

The inverter 30 is installed on one side of the motor unit 10 and controls the operation of the motor unit 10. The inverter 30 includes a housing 100 that forms the exterior thereof and a circuit board 110 received in the housing 100.

The housing 100 has a substantially cylindrical shape and has a protruding connector 104 on one side thereof. A plurality of fastening holes 102 is formed in the housing 100, and a fastening members pass through and is fastened to the fastening hole. As a result, the cover 200 to be described later can be coupled to the housing 100. In the embodiment, the housing 100 is a separate housing that forms the exterior of the inverter 30. Unlike this, one housing that forms the overall exterior of the motor unit 10 and the inverter 30 may be integrally provided.

Elements 112 such as transistors, capacitors, inductors, fixed resistors, diodes, drivers, etc., are mounted on the circuit board 110 and control the motor unit 10. The circuit board 110 is in an approximate disk shape and is inserted into the housing 100. The element 112 protrudes to one side and may have different protrusion heights depending on its type.

The cover 200 includes a metal plate 210 formed in a shape corresponding to the inverter 30, a first resin portion 220 that is injection-molded to be installed on the inside of the metal plate 210, and a second resin portion 240 that is installed on the outside of 210.

The metal plate 210 has a shape corresponding to the housing 100 in the inverter 30. That is, the metal plate 210 is roughly disk-shaped and has a shape in which an extension portion 214 is formed on and protrudes from the one side of the housing 100 where the connector 104 is positioned. In addition, the metal plate 210 is formed with a plurality of fastening holes 212 that allows the metal plate 210 to be coupled to the housing 100.

Here, a plurality of flanges 219 that protrudes further outward than the first and second resin portions 220 and 240 in a radial direction of the metal plate may be formed on the metal plate 210. Also, the fastening hole 212 may be formed to pass through the flange 219.

Referring to FIG. 4, a central plate portion 218 may be formed in the center of the metal plate 210. The central plate portion 218 may have a flat plate shape. The first resin portion 220 may be disposed on the inner surface of the central plate portion 218, and the second resin portion 240 may be disposed on the outer surface of the central plate portion 218. Additionally, a plurality of through holes 216 may be disposed at predetermined intervals along the outer perimeter of the central plate portion 218.

In the embodiment of the present disclosure, the central plate portion 218 may be formed relatively thicker than the remaining peripheral portion of the metal plate 210. This causes a central portion of the cover 200 to be formed thicker than other peripheral portions of the cover 200.

Accordingly, when shaking or resonance occurs due to vibration, on the cover 200, the central plate portion 218 can further suppress the shaking or resonance due to vibration than other portions of the cover 200. That is, the central portion of the cover 200 is formed thick, so that the thickness and weight of the central portion can effectively reduce the shaking or resonance due to vibration and reduce how much the shaking or resonance is transmitted.

The cover 200 not only protects the inverter 30 but also shields electromagnetic waves generated from the motor unit 10 or the inverter 30. For this purpose, the cover 200 includes the metal-made metal plate 210 that shows an electromagnetic wave shielding effect.

The first resin portion 220 is injection-molded to be installed on the inside of the metal plate 210. The first resin portion 220 is made of a plastic resin material.

At least a portion of the first resin portion 220 may be formed to face the circuit board 110. Referring to FIG. 2, in the embodiment of the present disclosure, the first resin portion 220 may be formed to face the entire circuit board 110.

Meanwhile, the through hole 216 as a flow path through which plastic resin can pass when the first resin portion 220 is injection-molded is formed in the metal plate 210. The through holes 216 are formed in plural numbers spaced apart in the circumferential direction.

The first resin portion 220 includes an inner surface 222 and a side wall 224. The inner surface 222 has a disk shape as a whole. The side wall 224 protrudes toward the circuit board 110 along the perimeter of the inner surface 222.

A plurality of ribs 226 protruding toward the circuit board 110 is formed on the inner surface 222. The rib 226 may be formed in the form of a hexagonal honeycomb structure. The rib 226 protrudes to a height less than the side wall 224. Such a rib 226 can function to improve the rigidity of the first resin portion 220. Here, the rib 226 is formed so as not to interfere with the element 112 mounted on the circuit board 110.

A sealing member seating portion on which a sealing member 230 may be installed is formed on the outer peripheral surface of the side wall 224. The sealing member 230 seals a gap between the housing 100 and the cover 200 and prevents the circuit board 110 from being damaged by the introduction of foreign substances such as moisture, etc., into the inside of the housing 100.

The second resin portion 240 is injection-molded on the outside of the metal plate 210 in a ring shape. The second resin portion 240 is installed in the circumferential direction in which the through hole 216 is formed, and thus, has a shape that covers the through hole 216.

Here, the first resin portion 220 and the second resin portion 240 pass through the through hole 216 and are integrally connected to each other. The first resin portion 220 and the second resin portion 240 are formed on opposite sides of each other with the metal plate 210 placed therebetween, but are connected to each other through the through hole 216.

Accordingly, the second resin portion 240 is placed in contact with the outer surface of the metal plate 210 and forms a support surface, and the first resin portion 220 is connected to the second resin portion 240 through the through hole 216. Therefore, the first resin portion 220 is supported by the support surface formed by the second resin portion 240, and the first resin portion 220 does not separate from the inner surface of the metal plate 210.

Meanwhile, an electric compressor according to another embodiment of the present disclosure includes a motor unit 10, a compression unit 20, an inverter 30, and a cover 200. The cover 200 includes a metal plate 210, a first resin portion 220, and a second resin portion 240.

As shown in FIG. 5, the cover 200 of the electric compressor according to the embodiment of the present disclosure includes an area where ribs 226 formed on an inner surface 222 of the first resin portion 220 are formed to protrude at different heights.

Referring to FIG. 5, the rib 226 may include middle ribs 228 that have a relatively lower protrusion height than other ribs.

Specifically, the middle rib 228 having a lower height than other ribs 226 may be formed in some areas. The middle rib 228 is intended to avoid interference with the element 112 mounted on the circuit board 110.

That is, in the case of a relatively large element, the element may come into contact with the ribs 226. Therefore, in order that the element is separated from the ribs 226, the middle ribs 228 are formed in the area where the large protruding elements are located, so that the element does not come into contact with the ribs 226. In this case, the middle rib 228 may have a greater spaced distance from the element than those of other ribs.

When several large elements are mounted on the circuit board 110, the middle ribs 228 may be formed in a plurality of different areas on the first resin portion 220.

Meanwhile, although not shown in the drawings, in the embodiment of the present disclosure, a portion of the inner surface of the first resin portion 220 is formed with an avoidance portion (not shown) that is formed to have a relatively greater spaced distance from the circuit board 110.

This intends to form an avoidance portion recessed in the opposite direction of the circuit board 110 on a portion of the inner surface of the first resin portion 220 when the ribs 226 are not formed on the inner surface of the first resin portion 220, thereby preventing interference with the parts mounted on the circuit board 110.

Hereinafter, operational effects of the electric compressor according to the embodiments of the present disclosure will be described.

According to the embodiments of the present disclosure, the second resin portion 240 is formed on the opposite side of the area where the sealing member 230 is positioned. Therefore, when the cover 200 is fastened to the inverter 30, a pressing force applied to the sealing member 230 can be sufficiently supported by the second resin portion 240.

In the embodiment of the present disclosure, the second resin portion 240 may be formed at a position corresponding to the sealing member seating portion into which the sealing member 230 is inserted.

This intends to ensure, because a pressing force is applied to the sealing member 230 when the cover 200 is fastened and fixed to the inverter 30, that the corresponding portion is sufficiently supported and the coupling force of the first and second resin portions 220 and 240 is maintained sufficiently along both sides of the metal plate 210.

Also, this intends to form the second resin portion 240 only in a limited area where the pressing force is mainly applied, for the purpose of reducing the weight without having to form the second resin portion 240 over the entire surface opposite to the surface facing the circuit board 110 of the inverter 30.

Here, since the sealing member seating portion for mounting the sealing member 230 is formed in the first resin portion 220, the sealing member 230 is not directly mounted on the metal plate 210 and the sealing member seating portion for the sealing member 230 does not need to be processed. Therefore, there is no requirement for an additional metal processing process for mounting the sealing member 230. The first resin portion 220 is made of a plastic resin material, and thus, is relatively easy to process. As a result, the processing cost can be reduced.

Also, since the first resin portion 220 and the second resin portion 240 are integrally connected, a sufficient coupling force between the first resin portion 220 and the second resin portion 240 can be obtained.

Here, since the first resin portion 220 and the second resin portion 240 are integrally injection-molded, the manufacturing process of the cover 200 can be simplified.

Also, since the first resin portion 220 is formed only as much as the size of the circuit board 110 instead of being formed on entire one surface of the metal plate 210, the weight of the cover 200 can be reduced.

Also, unlike the first resin portion 220, the second resin portion 240 is formed only in some areas where the pressing force is concentrated, so that the weight of the cover 200 can be further reduced.

Also, the middle rib 228 is formed on the inner surface 222 of the first resin portion 220, thereby avoiding interference with the element mounted on the circuit board.

The present disclosure relates to an electric compressor and has industrial applicability.

1. An electric compressor comprising:
a motor unit configured to generate power;
a compression unit configured to receive the power from the motor unit and to compress a refrigerant;
an inverter configured to control the motor unit; and
a cover configured to be coupled to one side of the inverter,
wherein the cover further comprises:
a metal plate;
a first resin portion configured to be disposed on an inside of the metal plate; and
a second resin portion configured to be disposed on an outside of the metal plate in such a way as to correspond to some areas of the first resin portion.

2. The electric compressor of claim 1, wherein the inverter further comprises a housing that forms an exterior thereof, and a circuit board which is received in the housing and on which a plurality of elements is mounted, and wherein at least a portion of the first resin portion is formed to face the circuit board.

3. The electric compressor of claim 1, wherein the second resin portion corresponds to a peripheral shape of the first resin portion and is formed to have a predetermined area.

4. The electric compressor of claim 1, wherein the first resin portion and the second resin portion are integrally injection-molded.

5. The electric compressor of claim 2, wherein a plurality of through holes is formed in the metal plate, and wherein the first resin portion and the second resin portion are integrally connected through the plurality of through holes.

6. The electric compressor of claim 5, wherein the plurality of through holes is disposed along an outer perimeter of the first resin portion and the second resin portion.

7. The electric compressor of claim 5, wherein the first resin portion further comprises an inner surface that is formed to have a shape corresponding to the circuit board, and a side wall that protrudes toward the circuit board along a perimeter of the inner surface.

8. The electric compressor of claim 7, wherein a sealing member seating portion is integrally formed on an outer peripheral surface of the side wall, and wherein a sealing member is mounted on the sealing member seating portion.

9. The electric compressor of claim 8, wherein the second resin portion is formed at a position corresponding to the sealing member seating portion.

10. The electric compressor of claim 9, wherein the second resin portion is formed on opposite sides of the sealing member seating portion and the sealing member with the metal plate placed therebetween and covers the plurality of through holes.

11. The electric compressor of claim 7, wherein a ribs protruding toward the circuit board are formed on the first resin portion.

12. The electric compressor of claim 11, wherein the ribs protrude to a height less than the side wall.

13. The electric compressor of claim 7, wherein a portion of the inner surface of the first resin portion further comprises an avoidance portion that is formed to have a relatively greater spaced distance from the circuit board.

14. The electric compressor of claim 11, further comprising an area where the ribs are formed to protrude at different heights such that the ribs avoid interference with the plurality of elements.

15. The electric compressor of claim 11, wherein the ribs further comprise a middle rib that has a relatively lower protrusion height than other of the ribs, and wherein the middle rib is formed to have a greater spaced distance from the plurality of elements than those of the other of the ribs.

16. The electric compressor of claim 1, wherein a central plate portion is formed in a center of the metal plate, and wherein the central plate portion is formed relatively thicker than other portions of the metal plate.

17. The electric compressor of claim 1, wherein the metal plate further comprises a plurality of flanges that protrudes further outward than the first resin portion and the second resin portion in a radial direction of the metal plate, and wherein a fastening hole is formed to pass through the plurality of flanges.
